(19) United States
(12) Patent Application Publication
(10) Pub. No.: US 2005/0199543 A1
(43) Pub. Date: Sep. 15, 2005

(54) Filter for plastic feed stock

(76) Inventor: Ted A. Burcham, McKinney, TX (US)

Correspondence Address: Michael A. O'Neil;Michael A. O'Neil, P.C., Suite 820, 5949 Sherry Lane, Dallas, TX, 75225, US

(21) Appl. No.: 11/061,389

(22) Filed: Feb. 18, 2005

Related U.S. Application Data
(60) Provisional application No. 60/552,410, filed on Mar. 11, 2004.

(51) Int. Cl. B01D 35/02

(52) U.S. Cl. 210/459; 425/297; 210/456; 210/460

(57) ABSTRACT

A supply system for a plastic plant comprises a supply vehicle for delivering plastic feed stock to the site of the plastic plant, a first conduit for delivering plastic feed stock from the supply vehicle to a storage silo, and a second conduit for delivering plastic feed stock from the storage silo to the plastic plant. A filter is positioned in the first conduit for preventing conglomerations of components of the plastic feed stock and fibrous mats formed from components of the plastic feed stock from entering the storage silo and thereby preventing fouling of the plastic plant.

### CLAIM OF PRIORITY

This application claims priority of prior provisional Application Ser. No. 60/552,410 filed Mar. 11, 2004.

### TECHNICAL FIELD

This invention relates generally to the transfer of plastic feed stock from a vehicle to a plastic plant, and more particularly to a filter for preventing irregularities in the plastic feed stock from entering the plastic plant.

### BACKGROUND AND SUMMARY OF THE INVENTION

The operation of a plastic plant requires a more or less continuous input of plastic feed stock comprising pellets or the like. Typically, plastic feed stock is delivered to the plastic plant in a vehicle which includes a pump. From the vehicle the plastic feed stock is directed through a conduit to a silo for storage. From the silo the plastic feed stock is directed through a conduit to the plastic plant for use in the manufacture of plastic products.

Although the foregoing process ordinarily takes place without incident, the pellets or other configurations comprising the plastic feed stock occasionally conglomerate into a bulbous mass having dimensions substantially larger than those of the individual pellets or other configurations comprising the plastic feed stock. If a conglomeration of individual components comprising the plastic feed stock is allowed to enter the machinery of the plastic plant, clogging can occur. In such instances it is necessary to discontinue the operation of the plastic plant, disassemble the machinery thereof, remove the clog, reassemble the machinery, and restart the plastic plant, an operation that can require several hours or more.

The pellets or other configurations comprising the plastic feed stock can also form fibrous mat having dimensions substantially larger than those of the individual pellets or other configurations comprising the plastic feed stock. If a fibrous mat formed from the individual components of the plastic feed stock is allowed to enter the machinery of the plastic plant, clogging can occur. In such instances it is necessary to discontinue the operation of the plastic plant, disassemble the machinery thereof, remove the clog, reassemble the machinery, and restart the plastic plant, an operation that can require several hours or more.

In accordance with the present invention there is provided a filter which prevents conglomerations of the individual components of the plastic feed stock and fibrous mats formed from the components of the plastic feed stock from entering the plastic plant and fouling the machinery thereof. Preferably the filter of the present invention is installed in the conduit extending between a plastic feed stock delivery vehicle and the storage silo which initially receives the plastic feed stock. The filter of the present invention prevents conglomerations of the component parts of the plastic feed stock and fibrous mats formed from the components of the plastic feed stock from entering the storage silo, thereby preventing fouling of the plastic plant components. The filter of the present invention is easily removed to facilitate cleaning thereof.

### BRIEF DESCRIPTION OF THE DRAWINGS

A more complete understanding of the present invention may be had by reference to the following Detailed Description when taken in connection with the accompanying Drawings, wherein:

FIG. 1 is an illustration of the plastic feed stock supply system for a plastic plant showing the filter of the present invention installed therein;

FIG. 2 is a side view of the filter for plastic feed stock of the present invention; and

FIG. 3 is a sectional view taken along the line 3-3 in FIG. 2 in the direction of the arrows.

FIG. 4 is a sectional view similar to FIG. 3 showing a second embodiment of the filter for plastic feed stock of the present invention;

FIG. 5 is a view similar to FIG. 2 showing a plastic feed stock supply system with the filter of the present invention retrofitted thereon;

FIG. 6 is a view similar to FIG. 5 showing a plastic feed stock supply system having the filter of the present invention installed thereon by a compression coupler; and

FIG. 7 is a view similar to FIG. 6 showing a plastic feed stock supply system having the filter of the present invention installed thereon by a weld.

### DETAILED DESCRIPTION OF THE DRAWINGS

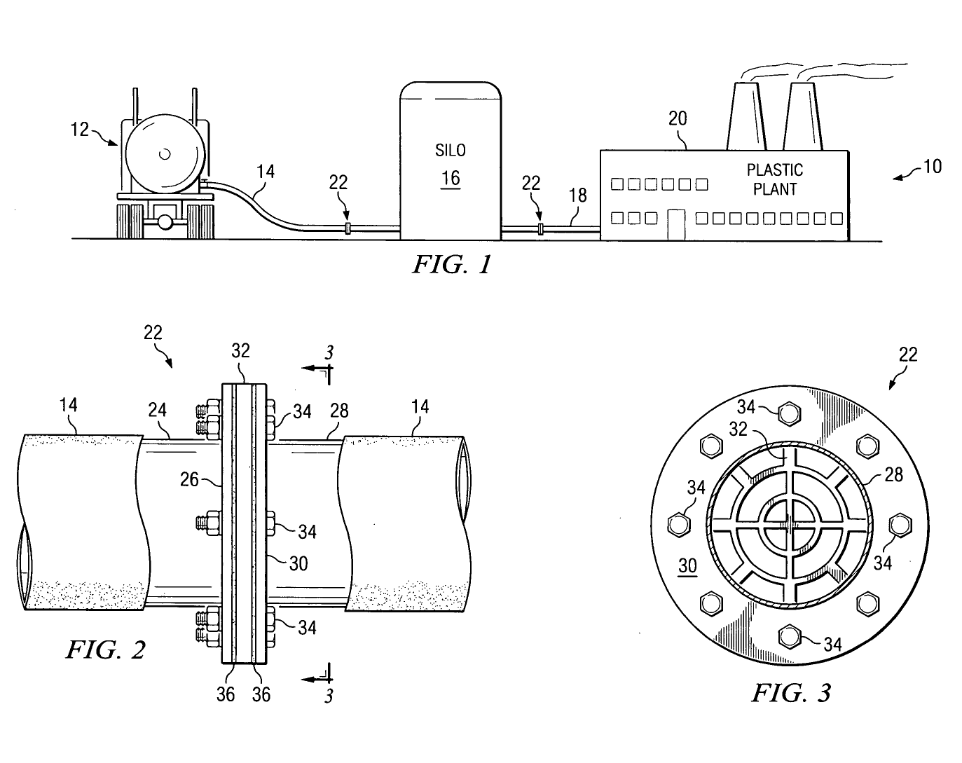

Referring now to the Drawings, and particularly to FIG. 1 thereof, there is shown a system 10 for supplying plastic feed stock to a plastic plant. Plastic feed stock in the form of pellets or the like is delivered to the site of a plastic plant in a supply vehicle 12 which typically includes a pump. The pump associated with a vehicle 12 directs plastic feed stock from the vehicle 12 through a conduit 14 to a storage silo 16. From the storage silo 16 the plastic feed stock is directed through a conduit 18 to a plastic plant 20.

As will be appreciated by those skilled in the art, the supply vehicle 12 may take a variety of forms. For example, the supply vehicle 12 may comprise a truck, a semi-trailer, or a full trailer. The supply vehicle 12 may also comprise a container similar in size and shape to an overseas shipping container. The supply vehicle 12 may also comprise a railroad car. The supply vehicle 12 may also comprise a ship, a boat, or a barge.

As will also be appreciated by those skilled in the art, the storage silo 16 may comprise a wide variety of shapes and sizes. Although the supply silo 16 is illustrated in FIG. 1 as comprising a free standing structure, the supply silo 16 may be incorporated into the plastic plant 20 depending upon the size of the supply silo 16 relative to the size of the plastic plant 20.

The term “plastic plant” as used herein means a manufacturing facility for receiving plastic feed stock in the form of pellets or other configurations and for utilizing the plastic feed stock in the manufacture of plastic articles. The manufacturing facilities comprising the plastic plant include, but are not limited to, extruders, blown film molding equipment, injection molding equipment, etc.

In accordance with the present invention a filter 22 is disposed in the conduit 14 extending between the vehicle 12 and the silo 16. Referring particularly to FIG. 2, the filter 22 comprises a pipe section 24 having a flange 26 secured to one end thereof and a pipe section 28 having a flange 30 secured to one end thereof. A filter component 32 is positioned between the flanges 26 and 30 and is secured in place by a plurality of threaded fasteners 34. Gaskets 36 are deployed between the filter component 32 and the flanges 26 and 30 to prevent leakage.

The pipe sections 24 and 28 and the flanges 26 and 30 comprising the filter 22 may be constructed from a variety of materials including aluminum, steel, stainless steel, and other metals; various plastics, fiberglass, etc. The flanges 26 and 30 may be secured to the pipe sections 24 and 28, respectively, by various well known techniques such as soldering, brazing, welding, utilization of various adhesives, utilization of compression couplers, utilization of various fasteners, etc. The filter component 32 may be fabricated from cast aluminum, however, other materials, particularly including various plastic materials, may be utilized in the fabrication of the filter component 32. The gaskets 36 may be formed from cork, other natural materials, various plastics, and other materials typically utilized in the construction of gaskets.

Although not shown in the drawings, the pipe sections 24 and 28 comprising the filter 22 are preferably secured within opposed ends of the conduit 14 extending between the supply vehicle 12 and the storage silo 16 by suitable clamps. For example, hose clamps of the type utilized in automotive installations may be utilized in the practice of the present invention. Toggle-type clamps and other quick disconnect clamps, for example, clamps of the type utilized in the construction of vacuum machinery may also be utilized in the practice of the present invention. Compression couplers and other similar coupling devices utilized in the practice of connecting pipes, conduit and the like may also be used to secured the pipe sections 24 and 28 within opposite ends of the conduit.

Referring again to FIG. 1, the filter 22 may also be placed in the conduit 18 extending between the silo 16 and the plastic plant 20 in addition to or alternative to placing the filter 22 in the conduit 14 between the supply vehicle 12 and the silo 16. The filter 22 may be secured to pipe sections within opposite ends of the conduit 18 by either soldering the flanges 26 and 30 directly to opposing pipe sections of the conduit, by utilization of compression couplers, or utilization of other suitable methods such as brazing, welding, utilization of adhesives, utilization of various fasteners, etc.

Referring particularly to FIG. 3, the filter 32 of the present invention may comprise a circular web configuration. The filter component 32 may also assume other configurations depending upon the requirements of particular applications of the invention.

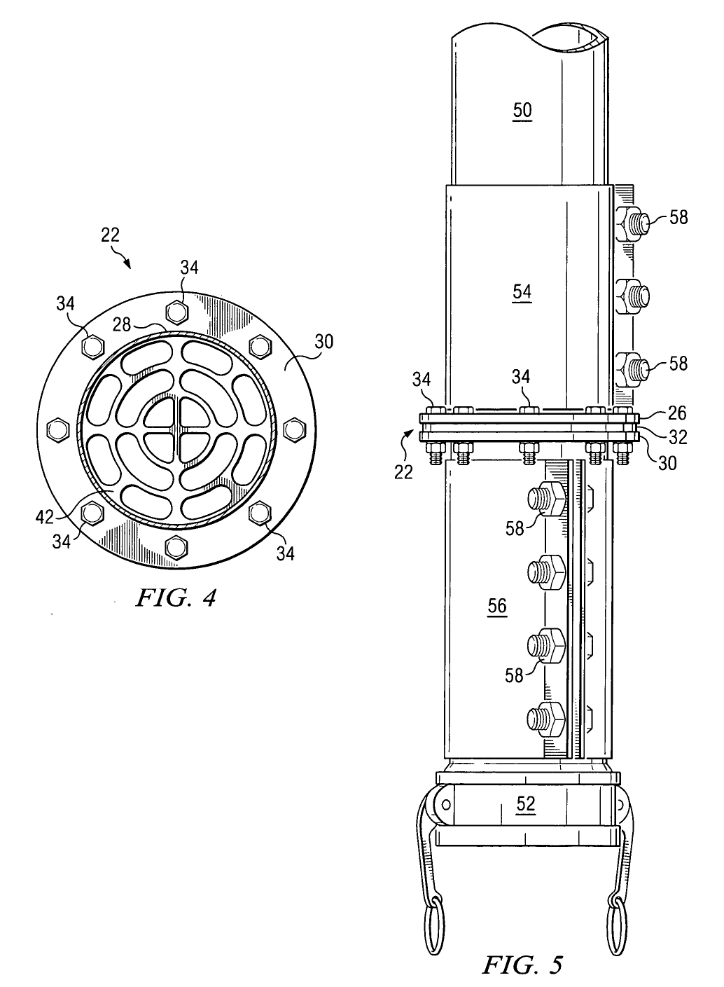

FIG. 4 shows a filter component 42 with a different shape and configuration than the filter component 32 illustrated in FIG. 3. The filter component 42 comprises rounded edges rather than the angular edges of the filter component 32.

FIG. 5 illustrates a conduit 50 extending from an existing silo retrofitted with the filter 22 of the present invention. Coupled below the filter 22 is an adapter 52 which is required for receiving a conduit extending directly from a supply vehicle. The filter 22 is secured to the conduit 50 by a compression coupler 54 secured around the flange 26 and the conduit 50. The adapter 52 is secured below the filter 22 by an additional compression coupler 56 which is secured around the flange 30 and the adapter 52. The compression couplers 54 and 56 are secured around the conduit 50 and flanges 26 and 30 by a plurality of threaded fasteners 58. The compression couplers 54 and 56 may be constructed from a variety of materials including aluminum, steel, stainless steel, and other metals; various plastics, fiberglass, etc.

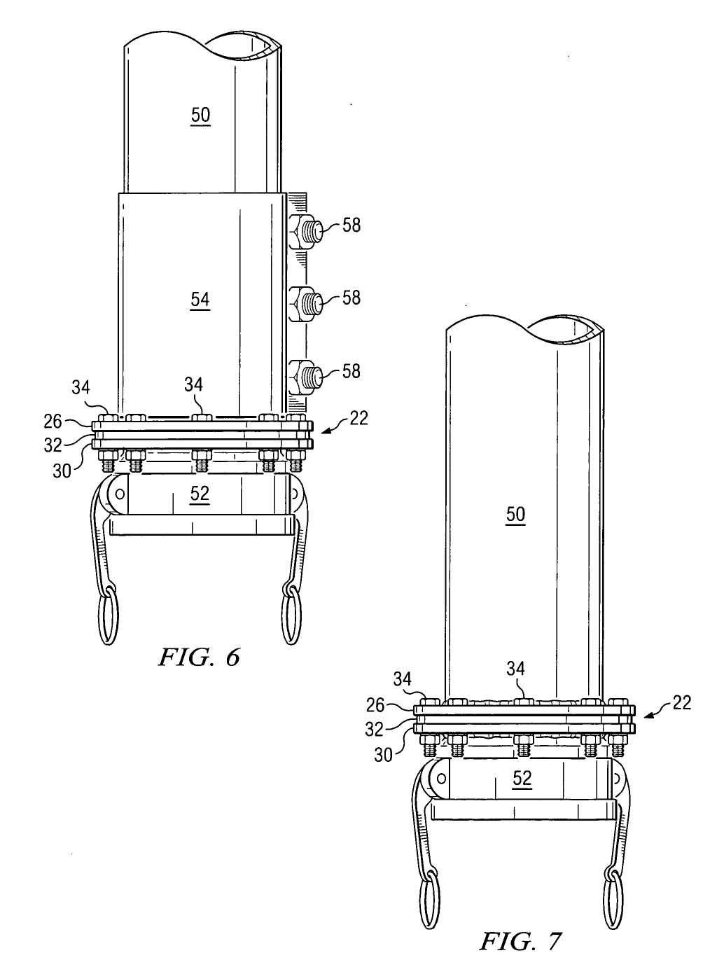

As shown in FIG. 6, instead of the adapter 52 being secured to the filter 22 by a compression coupler, the adapter 52 may be secured directly to the filter 22 by welding the adapter thereto or by other suitable substantially permanent adhesion methods known to those skilled in the art.

As shown in FIG. 7, the filter 22 may be secured directly to the conduit 50 by welding the filter 22 thereto or by other suitable substantially permanent adhesion methods known to those skilled in the art.

The purpose of the filter 22 of the present invention is to allow plastic feed stock to flow from the supply vehicle to the storage silo freely and easily while preventing conglomerations of individual components comprising the plastic feed stock from entering the storage silo. Similarly, the filter of the present invention prevents fibrous mats formed from component parts of the plastic feed stock from entering the storage silo. In this manner the filter of the present invention prevents either conglomerations of component parts of the plastic feed stock or fibrous mats formed from component parts of the plastic feed stock from entering the plastic plant and fouling the component parts thereof.

If a conglomeration of component parts comprising the plastic feed stock and/or a fibrous mat formed from component parts comprising the plastic feed stock enters the filter 22, the filter 22 may become clogged. In any such instance the clamps which secure the filter 22 and the conduit 14 are disengaged, the filter is removed from the conduit, and the filter is cleaned. The cleaning operation requires only a few minutes to complete, as compared with the extensive and time consuming operation that is required in order to unclog the machinery comprising the plastic plant 20. In the event that a conglomeration of components comprising the plastic feed stock and/or a fibrous mat formed from components comprising the plastic feed stock were to enter the machinery comprising the plastic plant 20.

Although preferred embodiments of the present invention are illustrated in the accompanied drawings and described in the foregoing detailed description, it will be understood that the invention is not limited to the embodiments disclosed but is capable of numerous rearrangements, modifications and substitutions in parts and elements without departing from the spirit of the invention.

1. For use in a plastic feed stock supply system of the type comprising a supply vehicle for transporting plastic feed stock to the site of the plastic plant, a first conduit for directing plastic feed stock from the supply vehicle to a storage silo, and a second conduit for directing plastic feed stock from the storage silo to the plastic plant, the improvement comprising:
a filter positioned in the first conduit for normally allowing plastic feed stock to flow freely from the supply vehicle to the storage silo and for preventing conglomerations of plastic feed stock components and fibrous mats formed from plastic feed stock components from entering the storage silo and thereby preventing fouling of the components of the plastic plant.

2. The improvement according to claim 1 wherein the filter is further characterized by:
a first pipe section operatively connected to the supply vehicle side of the first conduit;
a first flange secured to the first pipe section on the end thereof remote from the connection of the first conduit thereto;
a second pipe section operatively connected to the storage silo side of the first conduit;
a second flange secured to the second pipe section on the end thereof remote from the connection of the first conduit thereto; and
a filter component secured between the first and second flanges.

3. The improvement according to claim 2 wherein the filter component comprises a plurality of apertures which, in aggregate, normally facilitates the free flow of plastic feed stock through the filter, each of the apertures being dimensioned to prevent conglomerations of component parts of the feed stock and fibrous mats formed from component parts of the feed stock from passing through the filter.

4. For use in a plastic feed stock supply system of the type comprising a supply vehicle for transporting plastic feed stock to the site of the plastic plant, a first conduit for directing plastic feed stock from the supply vehicle to a storage silo, and a second conduit for directing plastic feed stock from the storage silo to the plastic plant, the improvement comprising:
a filter positioned in the second conduit for normally allowing plastic feed stock to flow freely from the storage silo to the plastic plant and for preventing conglomerations of plastic feed stock components and fibrous mats formed from plastic feed stock components from entering the plastic plant and thereby preventing fouling of the components of the plastic plant.

5. The improvement according to claim 4 wherein the filter is further characterized by:
a first pipe section operatively connected to the storage silo side of the second conduit;
a first flange secured to the first pipe section on the end thereof remote from the connection of the second conduit thereto;
a second pipe section operatively connected to the plastic plant side of the second conduit;
a second flange secured to the second pipe section on the end thereof remote from the connection of the second conduit thereto; and
a filter component secured between the first and second flanges.

6. The improvement according to claim 5 wherein the filter component comprises a plurality of apertures which, in aggregate, normally facilitates the free flow of plastic feed stock through the filter, each of the apertures being dimensioned to prevent conglomerations of component parts of the feed stock and fibrous mats formed from component parts of the feed stock from passing through the filter.

7. For use in a plastic feed stock supply system of the type comprising a supply vehicle for transporting plastic feed stock to the site of a plastic plant, a first conduit extending from a storage silo for receiving plastic feed stock from the supply vehicle; a second conduit for directing plastic feed stock from the storage silo to the plastic plant, and a third conduit extending from the supply vehicle coupled to the distal end of the first conduit, the improvement comprising:
a filter positioned between the first conduit and the and third conduit for normally allowing plastic feed stock to flow freely from the supply vehicle to the storage silo and for preventing conglomerations of plastic feed stock components and fibrous mats formed from plastic feed stock components from entering the storage silo and thereby preventing fouling of the components of the plastic plant.

8. The improvement according to claim 7 wherein the filter is further characterized by:
an adapter coupled to the distal end of the third conduit;
a first flange coupled to the adapter on the end thereof remote from the connection of the third conduit thereto;
a second flange coupled to the first conduit; and
a filter component secured between the first and second flanges.

9. The improvement according to claim 8 further wherein the adapter is coupled to the first flange by a compression coupler.

10. The improvement according to claim 8 wherein the adapter is coupled directly to the first flange.

11. The improvement according to claim 8 further wherein the second flange is coupled to the first conduit by a compression coupler.

12. The improvement according to claim 8 further wherein the second flange is coupled directly to the first conduit.
